(19) United States
(12) Patent Application Publication
(10) Pub. No.: US 2007/0150895 A1
(43) Pub. Date: Jun. 28, 2007

(54) Methods and apparatus for multi-core processing with dedicated thread management

(76) Inventor: Aaron S. Kurland, Lexington, MA (US)

Correspondence Address: GOODWIN PROCTER LLP;PATENT ADMINISTRATOR, EXCHANGE PLACE, BOSTON, MA, 02109-2881, US

(21) Appl. No.: 11/634,512

(22) Filed: Dec. 6, 2006

Related U.S. Application Data
(60) Provisional application No. 60/742,674, filed on Dec. 6, 2005.

(51) Int. Cl. G06F 9/46

(52) U.S. Cl. 718/102

(57) ABSTRACT

Methods and apparatus for dedicated thread management in a CMP having processing units, interface blocks, and function blocks interconnected by an on-chip network. In various embodiments, thread management occurs out-of-band allowing for fast, low-latency switching of threads without incurring the overhead associated with a software-based thread-management thread.

### CROSS-REFERENCE TO RELATED APPLICATIONS

The present application claims the benefit of co-pending U.S. provisional application No. 60/742,674, filed on Dec. 6, 2005, the entire disclosure of which is incorporated by reference as if set forth in its entirety herein.

### FIELD OF THE INVENTION

The present invention relates to methods and apparatus for the execution of computer instructions by a plurality of processor cores, and in particular to the use of dedicated thread management to execute computer instructions by a plurality of processor cores.

### BACKGROUND OF THE INVENTION

Computing requirements for applications such as multimedia, networking, and high-performance computing are increasing in both complexity and in the volume of data to be processed. At the same time, it is increasingly difficult to improve microprocessor performance simply by increasing clock speeds, as advances in process technology have currently reached the point of diminishing returns in terms of the performance increase relative to the increases in power consumption and required heat dissipation. Given these constraints, parallel processing appears to be a promising alternative for improving microprocessor performance.

Thread-level parallelism (TLP) is one parallel-processing technique in which program threads run concurrently, increasing the overall performance of an application. Broadly speaking, there are two forms of TLP: simultaneous multi-threading (SMT), and chip multi-processors (CMP).

SMT replicates registers and program counters on a single processing unit so that the states of multiple threads can be stored at once. In an SMT processor, these threads are partially executed one at a time and the processor quickly switches execution among threads, providing virtual concurrency of execution. This ability comes with the expense of added complexity in the processing unit, and additional hardware required by the duplicated registers and counters. Furthermore, the concurrency is still “virtual” -although the approach provides fast thread switching, it does not overcome the fundamental limitation that only a single thread is actually executed at any given time.

A CMP contains at least two processing units, with each processing unit executing its own thread. A CMP provides genuine concurrency compared to an SMT processor, but its performance potentially suffers from latency when a thread running on a given processing unit requires switching. A fundamental problem of these prior-art CMPs is that the thread-management task is executed in software on one or more processing units of the CMP itself, in many cases accessing off-chip memory to store the data structures necessary for thread management. This scheme decreases the number of processing units and memory bandwidth available for thread execution. In addition, since the thread-management task is itself one of the threads to be executed, it is limited in its ability to manage processing unit allocation, to schedule threads for execution, and to synchronize objects in real time.

Recently both SMT and CMP have been combined in hybrid implementations where multiple SMT processors are integrated onto a single chip. The result is a greater amount of both virtual and real parallelism in thread execution, but present hybrid implementations do not address the problems stemming from in-band thread management.

Accordingly, there is a need for methods and apparatus that address the shortcomings of the prior art by integrating a dedicated thread-management unit into a multi-core processor to provide improved microprocessor performance.

### SUMMARY OF THE INVENTION

The present invention addresses the shortcomings of existing SMT processors and CMPs by integrating dedicated thread-management into a CMP having processing units, interface blocks; and function blocks interconnected by an on-chip network. In this architecture, thread management occurs out-of-band allowing for fast, low-latency switching of threads without incurring the overhead associated with a software based thread-management thread.

In one aspect, the present invention provides a method for multi-core virtualization in a device having a plurality of processor cores. At least one scheduling instruction is received, as well as one instruction for execution. In response to the at least one scheduling instruction, the at least one instruction for execution is assigned to a processor core for execution. In one embodiment, assigning the instruction may be performed out-of-band. Assigning the at least one instruction may include selecting a processor core from a plurality of processor cores for executing the instruction and assigning the instruction for execution to the selected processor core. The processor core may be selected, for example, from a plurality of homogeneous processor cores. The power state of a processor core may optionally be changed.

In another embodiment, assigning the instruction includes identifying the thread associated with the instruction for execution and assigning the instruction for execution to a processor core associated with the identified thread. In still another embodiment, assigning the instruction includes selecting a processor core for execution from a plurality of processor cores utilizing at least one of power considerations and heat distribution considerations and assigning at least one instruction for execution to the selected processor core. In yet another embodiment, assigning the instruction includes selecting a processor core for execution from a plurality of processor cores utilizing stored processor state information and assigning at least one instruction for execution to the selected processor core.

In one embodiment, receiving at least one instruction for execution includes receiving a plurality of threads for execution, each thread including at least one instruction for execution, selecting a thread from the received plurality for execution, and receiving at least one instruction for execution from the selected thread.

In various embodiments, the method may also include several optional steps. The method may further include receiving a message from the processor core indicating that it has executed the assigned at least one instruction. Thread states and information or the state of the processor core may be stored. If an inter-thread dependency is detected after a processor core executes a first assigned instruction, the executed instruction may be reassigned after the execution of a second assigned instruction so that the first assigned instruction may be re-executed without inter-thread dependency.

In another aspect, the present invention provides a device having a plurality of processor cores and a thread management unit that receives an instruction for execution and a scheduling instruction and assigning the instruction for execution to a processor core in response to the scheduling instruction. The plurality of processor cores may be homogeneous, and the thread management unit may be implemented exclusively in hardware or in a combination of hardware and software. The processor cores, which may operate at different speeds, may be interconnected in a network, or connected by a network, and the network may be optical. The device may also include at least one peripheral device.

The thread management unit may include one or more of a state machine, a microprocessor, and a dedicated memory. The microprocessor may be dedicated to one or more of scheduling, thread management, and resource allocation. The thread management unit may be dedicated to storing thread and resource information.

In still another aspect, the present invention provides a method for compiling a software program. A compilable source code statement is received and a machine-readable object code statement corresponding to the compilable source code statement is created. A machine-readable object code statement is added for signaling a thread management unit to assign the created machine-readable object code statement to a processor core.

The method may further include repeating the creation of a machine-readable object code statement to provide a plurality of created machine-readable object code statements and the organization of the plurality of statements into a plurality of threads, with each pair of threads separated by a boundary. In this embodiment, the addition of a statement for signaling a thread management unit includes adding a machine-readable object code statement for signaling a thread management unit at a boundary between threads. In another embodiment, the addition of a statement for signaling a thread management unit includes adding a machine-readable object code statement for signaling a thread management unit in response to a compilable source code statement indicating a boundary between threads.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1 is a block diagram of an embodiment of the present invention providing dedicated thread management in a multi-core environment;

FIG. 2 is a flowchart of a method for providing multi-core virtualization in a device having a plurality of processor cores in accord with the present invention;

FIG. 3 is a block diagram of an embodiment of the thread management unit; and

FIG. 4 is a flowchart of a method for compiling a software program for use with embodiments of the present invention.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

Embodiments of the present invention address the shortcomings of current multi-core techniques by integrating dedicated thread-management into a CMP having interconnected processing units, interface blocks, and function blocks. Thread management may be implemented exclusively in hardware or in a combination of hardware and software allowing for thread switching without the overhead of a software based thread-management thread.

Hardware embodiments of the present invention do not require the replicated registers and program counters of an SMT approach, making it simpler and cheaper than SMT, though the use of SMT in combination with the methods and apparatus of the present invention can yield additional benefits. The use of an on-chip network to connect the system blocks, including the management unit itself, provides a space-efficient and scalable interconnect that allows for the use of a large number of processing units and function blocks while providing flexibility in the management of power consumption. The thread-management unit communicates with the function blocks and handles processing unit and resource allocation, thread scheduling, and object synchronization within the system.

Embodiments of the present invention improve thread-level parallelism in a cost-effective way by combining an on-chip network architecture integrating a large number of processing units into a single integrated circuit having a dedicated thread-management unit that operates out-of-band, i.e., independent of any particular processing unit. In one embodiment, the thread-management unit is implemented completely in hardware, typically with its own dedicated memory and having global access to other function blocks. In other embodiments, the thread-management unit may be implemented substantially or partially in hardware.

The use of a dedicated thread-management unit in an on-chip network of processing units eliminates the overhead inherent to existing SMT and CMP approaches, where thread management is implemented as a software thread itself, resulting in an improvement in overall performance. Embodiments of the present invention realize greater parallelism of execution compared to existing SMT approaches by making the thread management global, rather than local to a specific processing unit. The globalization of thread management also allows for improved resource allocation, higher processor utilization, and global power management.

Architecture

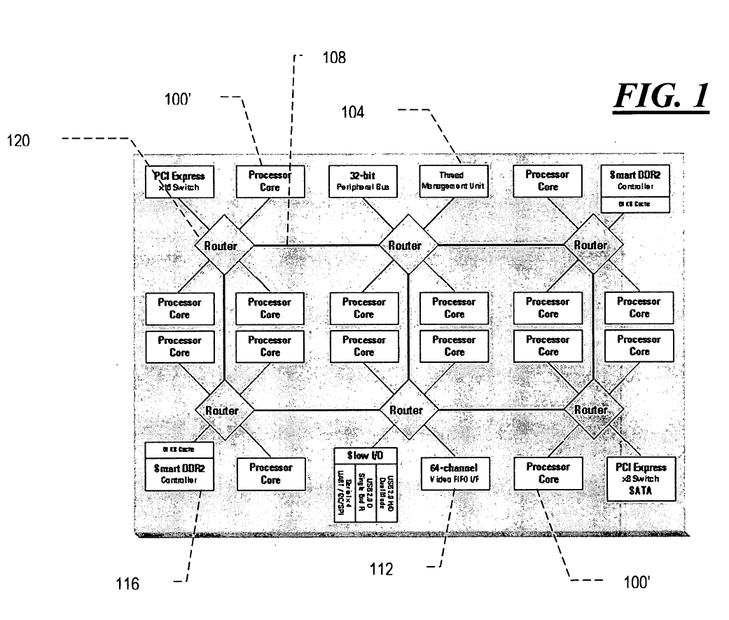

With reference to FIG. 1, a typical embodiment of the present invention includes at least two processing units 100, a thread-management unit 104, an on-chip network interconnect 108, and several optional components including, for example, function blocks 112, such as external interfaces, having network interface units (not explicitly shown), and external memory interfaces 116 having network interface units (again, not explicitly shown).

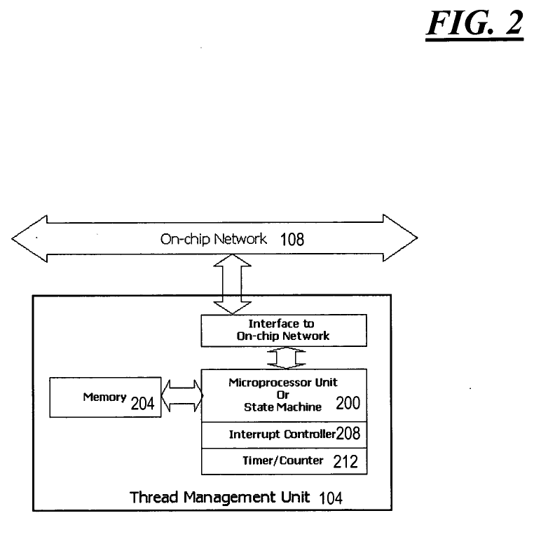

Each processing unit 100 includes, for example, a microprocessor core, data and instruction caches, and a network interface unit. As depicted in FIG. 2, embodiments of the thread-management unit 104 typically include a microprocessor core or a state machine 200, dedicated memory 204, and a network interface unit 208. The network interconnect 108 typically includes at least one router 120 and signal lines connecting the router 120 to the network interface units of the processing units 100 or other functional blocks 112 on the network.

Using the on-chip network fabric 108, any node, such as a processor 100 or functional block 112, can communicate with any other node. This architecture allows for a large number of nodes on a single chip, such as the embodiment presented in FIG. 1 having sixteen processing units 100. Each processing unit 100 has a microprocessor core with local cache memory and a network interface unit. The large number of processing units allows for a higher level of parallel computing performance. The implementation of a large number of processing units on a single integrated circuit is permitted by the combination of the on-chip network architecture 108 with the out-of-band, dedicated thread-management unit 104.

In a typical embodiment, communication among nodes over the network 108 occurs in the form of messages sent as packets which can include commands, data, or both.

Thread-Management Unit

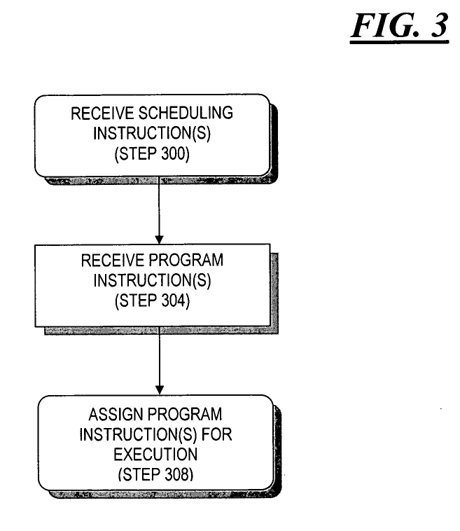

In operation, when the processor is initialized the thread-management unit begins execution and assigns one of the processing units to fetch and execute program instructions from memory. For example, with reference to FIG. 3, the thread-management unit may receive at least one scheduling instruction (Step 300) and at least one program instruction (Step 304) before assigning the program instruction for execution in response to the at least scheduling instruction (Step 308).

If, while executing the assigned instructions, the processing unit encounters a program instruction spawning another thread, it sends a message to the thread-management unit via the network. After receiving that message (Step 300′), the thread-management unit assigns another processing unit to fetch and execute instructions for that new thread (Step 308′), assuming the availability of further processing units. In this manner, multiple threads may be executed concurrently on multiple processing units until there are either no more pending threads to be assigned by the thread-management unit or available processing units. When there are no available processing units to be assigned, the thread-management unit will store additional threads in a run-queue inside its memory.

In some cases, the scheduling logic in the thread management unit may interrupt an executing thread and replace it with a thread having higher priority. In this case, the thread that was interrupted will be put in the run-queue so that the thread can be resumed when a processing unit becomes available.

When a given processing unit completes executing the instructions associated with an assigned thread, the processing unit sends a message to the thread-management unit indicating that it is now free (Step 300″). The thread-management unit may now assign a new thread for execution to the free processing unit (Step 308″) and the process repeats as long as there are threads to be executed. In some embodiments, the thread-management unit may idle a free processing unit to reduce overall power consumption, or in some cases may move an executing thread from one physical processing unit to another to better distribute power loads and dissipated heat.

The thread-management unit additionally monitors the state of the processing units and the function blocks on the chip to detect any stall conditions, i.e., in which a processing unit is waiting for another processing unit or function block to execute an instruction. The thread-management unit also tracks the state of individual threads, e.g., such as running, sleeping, waiting. The thread state information is stored in the management unit's local memory and is used by the management unit to make decisions on the scheduling of threads for execution.

Using known thread states and scheduling rules which, for example, may include any combination of priority, affinity, or fairness, the thread-management unit sends messages to particular processing units to execute instructions from a specified location in memory. Accordingly, the operation of any processing unit can be changed with very little latency at any given time based on a decision by the thread-management unit. The scheduling rules used by the thread-management unit are configurable, for example, on boot-up.

With further reference to FIG. 2, certain embodiments of the thread-management unit 104 may optionally include an interrupt controller 208 and a system timer/counter 212. In these embodiments, the thread-management unit 104 receives all interrupts first and then dispatches an appropriate message to the appropriate processing unit 100 or function block 112 for processing of the interrupt.

The thread-management unit may also support affinity between threads and system resources such as function blocks or external interfaces, and affinity between other threads. For example, a thread may be designated by a compiler or an end user as associated with a particular processor unit, function block, or another thread. The thread-management unit uses the thread's affinities to optimize the allocation of processing units to, for example, reduce the physical distance between a first processing unit running a particular thread and a processing unit or system resource with which the first unit has affinity.

Since the thread-management unit is not associated with any particular processing unit, but is instead an autonomous node on the on-chip network, thread management is processed out-of-band. This approach has several advantages over traditional thread management schemes that handle thread management in-band, either as a software thread or as hardware associated with a specific processing unit. First, out-of-band management incurs no thread management overhead on any of the processing units, freeing the processing units to handle computing tasks. Second, since threads and on-chip resources are managed across the entire on-chip network, rather than locally, it provides for better resource allocation and utilization and improves efficiency and performance. Third, the combination of an on-chip network and a centralized scheduling and synchronization mechanism allows for the multi-core architecture to scale to thousands of processing units. Lastly, an out-of-band thread-management unit can also idle system resources to reduce power consumption.

As depicted in FIG. 3, the thread-management unit 104 contains dedicated memory 204 for storing information it needs to perform the scheduling and management of threads. The information stored in the memory 204 may include a queue of threads to be scheduled for execution, the states of various processing units and function units, the states of various threads being executed, ownership and access rights of any locks, mutexes, or shared objects, and semaphores. Since the dedicated memory 204 is directly connected to the microprocessor or state machine 200 within the thread management unit 104, the thread management unit 104 is able to perform its functions without accessing shared or off-chip memory. This results in faster execution of scheduling and management tasks, as well as guaranteeing the number of clock cycles needed to perform a scheduling or management operation.

Software Development Process

The combination of an on-chip network of processing units and a dedicated, thread-management unit allows the thread-management process to be managed effectively without any explicit directions from a software developer. Accordingly, a software developer can take a new or existing multi-threaded software application and process it using a specialized compiler, a specialized linker, or both, for execution on embodiments of the present invention without modifying the underlying source code of the application itself.

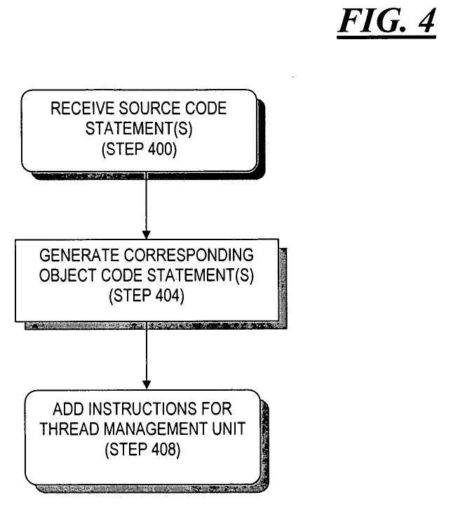

With reference to FIG. 4, in one embodiment the specialized compiler or linker changes the compilable source code statements (Step 400) into one or more machine-readable object code statements that correspond to the source code statement and are executable as threads by the processor units in the on-chip network (Step 404). The specialized compiler or linker also adds special machine-readable object code statements that signal a processing unit to begin the execution of instructions associated with a new thread (Step 408). These special statements may be placed, for example, at a boundary between threads that is either automatically identified by the compiler or linker, or specifically designated as a boundary by the developer.

Optionally, the compiler or a pre-processor may perform a static code analysis to extract and present additional opportunities for parallelism to the developer. Additional opportunities to exploit parallelism can be realized through the implementation of a run-time virtual machine for higher level languages such as JAVA.

It will therefore be seen that the foregoing represents a highly advantageous approach to multi-core processing utilizing dedicated thread management. The terms and expressions employed herein are used as terms of description and not of limitation and there is no intention, in the use of such terms and expressions, of excluding any equivalents of the features shown and described or portions thereof, but it is recognized that various modifications are possible within the scope of the invention claimed.

What is claimed is:

1. A method for multi-core virtualization in a device having a plurality of processor cores, the method comprising:
receiving at least one scheduling instruction;
receiving at least one instruction for execution; and
in response to the at least one scheduling instruction, assigning at least one instruction for execution to a processor core for execution.

2. The method of claim 1 wherein assigning the at least one instruction is performed out-of-band.

3. The method of claim 1 wherein assigning the at least one instruction comprises:
selecting a processor core for execution from a plurality of processor cores; and
assigning at least one instruction for execution to the selected processor core.

4. The method of claim 3 wherein selecting the processor core comprises selecting a processor core for execution from a plurality of homogeneous processor cores.

5. The method of claim 1 wherein assigning the at least one instruction comprises:
identifying the thread associated with the at least one instruction for execution; and
assigning at least one instruction for execution to a processor core associated with the identified thread.

6. The method of claim 1 further comprising changing the power state of a processor core.

7. The method of claim 1 wherein assigning the at least one instruction comprises:
selecting a processor core for execution from a plurality of processor cores utilizing at least one of power considerations and heat distribution considerations; and
assigning at least one instruction for execution to the selected processor core.

8. The method of claim 1 further comprising receiving a message from the processor core indicating that it has executed the assigned at least one instruction.

9. The method of claim 1 further comprising storing the state of the processor core.

10. The method of claim 1 further comprising storing thread states and information.

11. The method of claim 9 wherein assigning the at least one instruction comprises:
selecting a processor core for execution from a plurality of processor cores utilizing stored processor state information; and
assigning at least one instruction for execution to the selected processor core.

12. The method of claim 1 wherein receiving at least one instruction for execution comprises:
receiving a plurality of threads for execution, each thread comprising at least one instruction for execution;
selecting a thread from the received plurality for execution; and
receiving at least one instruction for execution from the selected thread.

13. The method of claim 1 further comprising:
detecting an inter-thread dependency after a processor core executes a first assigned instruction; and
reassigning the executed instruction after the execution of a second assigned instruction,
wherein the execution of the second assigned instruction permits the re-execution of the first assigned instruction without the inter-thread dependency.

14. A device comprising:
a plurality of processor cores; and
a thread management unit,
wherein the thread management unit receives an instruction for execution and a scheduling instruction; and
the thread management unit assigns the instruction for execution to a processor core in response to the scheduling instruction.

15. The device of claim 14 wherein the plurality of processor cores are homogeneous.

16. The device of claim 14 wherein the thread management unit is implemented exclusively in hardware.

17. The device of claim 14 wherein the thread management unit is implemented in hardware and software.

18. The device of claim 14 wherein the processor cores are interconnected in a network.

19. The device of claim 14 wherein the processor cores are connected by a network.

20. The device of claim 14 wherein the processor cores are interconnected by an optical network.

21. The device of claim 14 wherein the thread management unit comprises a state machine.

22. The device of claim 14 wherein the thread management unit comprises a microprocessor that is dedicated to one or more of scheduling, thread management, and resource allocation.

23. The device of claim 14 wherein the thread management unit comprises dedicated memory for storing thread and resource information.

24. The device of claim 14 further comprising at least one peripheral device.

25. The device of claim 14 wherein at least two of the plurality of processor cores operate at different speeds.

26. A method for compiling a software program, the method comprising:
receiving a compilable source code statement;
creating a machine-readable object code statement corresponding to the compilable source code statement; and
adding a machine-readable object code statement for signaling a thread management unit to assign the created machine-readable object code statement to a processor core.

27. The method of claim 26 further comprising:
repeating the creation of a machine-readable object code statement to provide a plurality of created machine-readable object code statements; and
organizing the plurality of statements into a plurality of threads, each pair of threads separated by a boundary.

28. The method of claim 27 wherein the addition of a statement for signaling a thread management unit comprises adding a machine-readable object code statement for signaling a thread management unit at a boundary between threads.

29. The method of claim 26 wherein the addition of a statement for signaling a thread management unit comprises adding a machine-readable object code statement for signaling a thread management unit in response to a compilable source code statement indicating a boundary between threads.
